(19) United States
(12) Patent Application Publication
(10) Pub. No.: US 2024/0192706 A1
(43) Pub. Date: Jun. 13, 2024

(54) Transport Facility

(71) Applicant: Daifuku Co., Ltd., Osaka-shi (JP)

(72) Inventors: Shuei Seno, Hinocho (JP); Hiroki Omoto, Hinocho (JP)

(21) Appl. No.: 18/530,675

(22) Filed: Dec. 6, 2023

(30) Foreign Application Priority Data
Dec. 7, 2022 (JP) 2022-195566

(51) Int. Cl. G05D 1/672

(52) U.S. Cl. CPC G05D 1/672; G05D 2107/70

(57) ABSTRACT

An automated guided vehicle has a coupler configured to be coupled to a body of a carriage in such a manner that the coupler is restricted from rotating about an up-down axis relative to the body, and the automated guided vehicle drives a drive wheel with a drive source to move the carriage, while the coupler is coupled to the body at a position outward of a supporter in a width direction, the supporter being configured to support an object to be transported.

### CROSS-REFERENCE TO RELATED APPLICATION

This application claims priority to Japanese Patent Application No. 2022-195566 filed Dec. 7, 2022, the disclosure of which is hereby incorporated by reference in its entirety.

### BACKGROUND OF THE INVENTION

### 1. Field of the Invention

The present invention relates to a transport facility that includes a carriage and an automated guided vehicle.

### 2. Description of Related Art

For example, parts may be transported and assembled in a factory or the like on a carriage that travels on a floor surface, and in such a case, an automated guided vehicle may be used to move the carriage. If this is the case, the factory or the like is equipped with a transport facility for transporting the carriage. An example of such a transport facility is disclosed in JP 2007-76518A (Patent Document 1).

The transport facility according to Patent Document 1 includes carriages (carriages A to G) on which objects (parts) to be transported are placed, and automated guided vehicles (automated transport devices x to z) that move the carriages as a result of being self-propelled in the state of being coupled to the carriages. In the transport facility according to Patent Document 1, the automated guided vehicles are each disposed directly below a supporter (a work table 45) that supports an object to be transported, and are each coupled to a carriage by a coupling structure (a pin engagement hole 49 and a hook pin 103).

In the transport facility according to Patent Document 1, each automated guided vehicle is disposed directly below a supporter, and is coupled to a carriage with use of the coupling structure at a position directly below the supporter. With such a configuration, it is conceivable that the carriages can be moved stably on average when the automated guided vehicles are self-propelled. However, there is a problem in that if a structure or a mechanism necessary for a carriage is present directly below, or forward of, or rearward of the supporter of the carriage, it is difficult to couple the automated guided vehicle and the carriage to each other.

### SUMMARY OF THE INVENTION

Therefore, in view of the foregoing, it is desired to realize a transport facility in which, even if there is no space for the automated guided vehicle to be placed directly below, or forward of, or rearward of the supporter of the carriage, the automated guided vehicle can be coupled to the carriage and the carriage can be driven by the drive force of the automated guided vehicle.

A transport facility according to the present disclosure is a transport facility including: a carriage configured to support an object to be transported; and an automated guided vehicle configured to be coupled to the carriage and self-propelled to move the carriage on a floor surface. The automated guided vehicle includes: a coupler configured to be coupled to the carriage; a drive wheel configured to roll on the floor surface; and a drive source configured to drive the drive wheel, the carriage includes: a supporter configured to support the object to be transported; a plurality of wheels configured to roll on the floor surface; and a body to which the supporter and the plurality of wheels are attached, with a travel direction being a direction in which the carriage travels, and a width direction being a direction orthogonal to the travel direction as viewed in an up-down direction, the coupler is configured to be coupled to the body in such a manner that the coupler is restricted from rotating about an up-down axis relative to the body, and the automated guided vehicle drives the drive wheel with the drive source to move the carriage, while the coupler is coupled to the body at a position outward of the supporter in the width direction.

With this configuration, even if there is no space for the automated guided vehicle to be placed directly below, or forward of, or rearward of the supporter of the carriage, the automated guided vehicle can be coupled to the carriage and the carriage can be moved by the drive force of the automated guided vehicle. At this time, the coupler is coupled to the body in the state where relative rotation of the coupler about the up-down axis is restricted. Therefore, even if the automated guided vehicle is coupled only to one side of the carriage in the width direction, rather than to two sides in the width direction, it is easier to prevent the travel direction of the carriage and the travel direction of the automated guided vehicle from being misaligned with each other. Therefore, even if a structure or a mechanism necessary for the carriage is present directly below, or forward of, or rearward of the supporter of the carriage, the carriage can be moved by the automated guided vehicle.

### BRIEF DESCRIPTION OF THE DRAWINGS

FIG. 1 is a diagram showing an example of a layout of a transport facility.

FIG. 2 is a side view of a carriage and an automated guided vehicle shown in FIG. 1.

FIG. 3 is a rear view of the carriage and the automated guided vehicle in FIG. 2.

FIG. 4 is a plan view of the carriage and the automated guided vehicle in FIG. 2.

FIG. 5 is a diagram illustrating couplers of the automated guided vehicle in FIG. 2.

FIG. 6 is a diagram illustrating a right turn made by the automated guided vehicle in FIG. 2 in an uncoupled state.

FIG. 7 is a diagram illustrating a left turn made by the automated guided vehicle in FIG. 2 in an uncoupled state.

FIG. 8 is a diagram illustrating a right turn made by the automated guided vehicle and the carriage in FIG. 2.

FIG. 9 is a diagram illustrating straight travel of the automated guided vehicle and the carriage in FIG. 2.

FIG. 10 is a diagram illustrating a left turn made by the automated guided vehicle and the carriage in FIG. 2.

FIG. 11 is a plan view of a carriage and an automated guided vehicle according to another embodiment.

FIG. 12 is a plan view of a carriage and an automated guided vehicle according to another embodiment.

FIG. 13 is a plan view of a carriage and an automated guided vehicle according to another embodiment.

### DESCRIPTION OF THE INVENTION

Hereinafter, embodiments of a transport facility will be described with reference to the drawings.

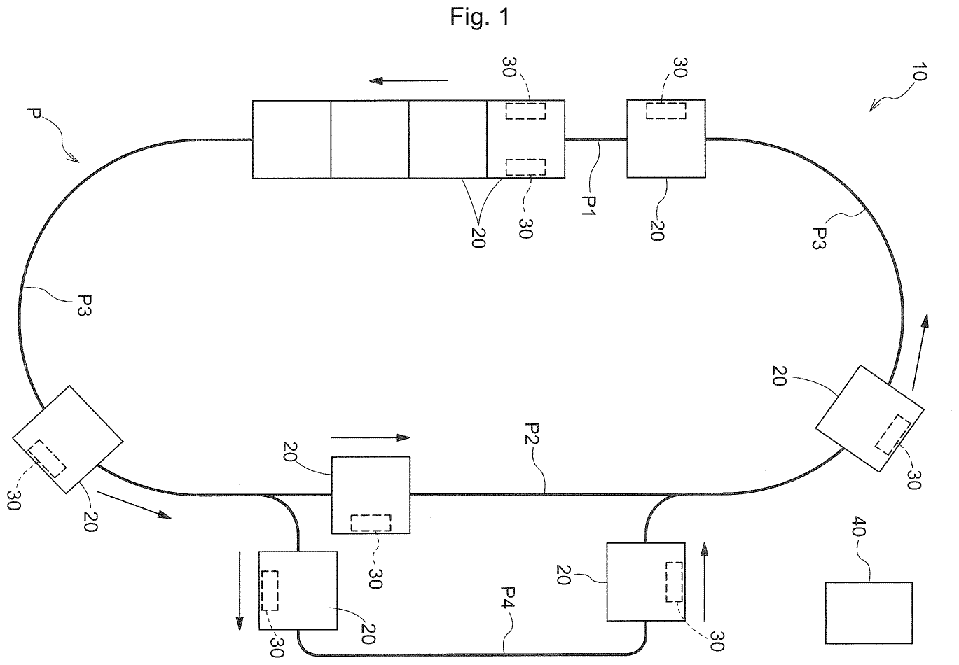

FIG. 1 is a layout diagram for a transport facility 10 according to an embodiment. The transport facility 10 is used to transport objects B to be transported in, for example, factories, warehouses, ships, or the like. The transport facility 10 includes carriages 20 and automated guided vehicles 30.

In the present embodiment, each carriage 20 is coupled to an automated guided vehicle 30 and travels along a travel path P together with the automated guided vehicle 30. Here, the travel path P is a path along which the carriages 20 and the objects B to be transported placed thereon are transported. The travel path P may be a path determined in advance with use of physical means such as rails, or a path determined each time by software, with use of guiding means such as magnetic markers, pieces of light-reflecting tape, electromagnetic induction cables, or two-dimensional markers.

The travel path P in the present embodiment includes a first straight section P1, a second straight section P2, curved sections P3, and a detour section P4. The first straight section P1 and the second straight section P2 are arranged parallel to each other and are connected to each other by the curved sections P3 at both ends of each straight section. The detour section P4 is provided to allow vehicles to bypass a portion of the second straight section P2.

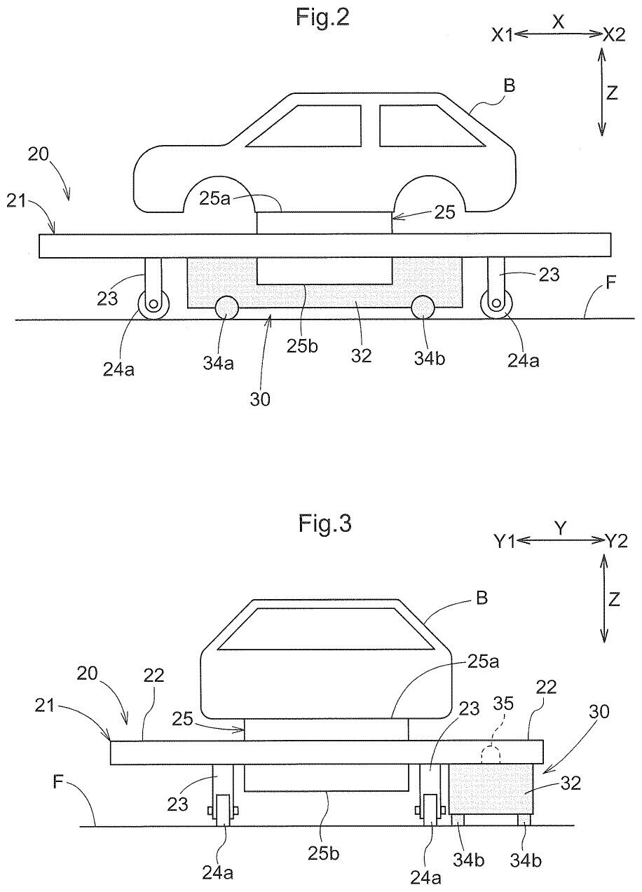

FIG. 2 is a side view of a carriage 20 and an automated guided vehicle 30. FIG. 3 is a rear view of the carriage 20 and the automated guided vehicle 30. In the present embodiment, the carriage 20 supports the object B to be transported. The automated guided vehicle 30 travels with use of self-propulsion while coupled to the carriage 20, thereby moving the carriage 20 on a floor surface F. For example, the object B to be transported is the body of a vehicle, and the transport facility 10 can be used in an automobile manufacturing factory where automobiles are assembled by sequentially attaching various parts to objects B to be transported on carriages 20 while moving the carriages 20 with use of automated guided vehicles 30.

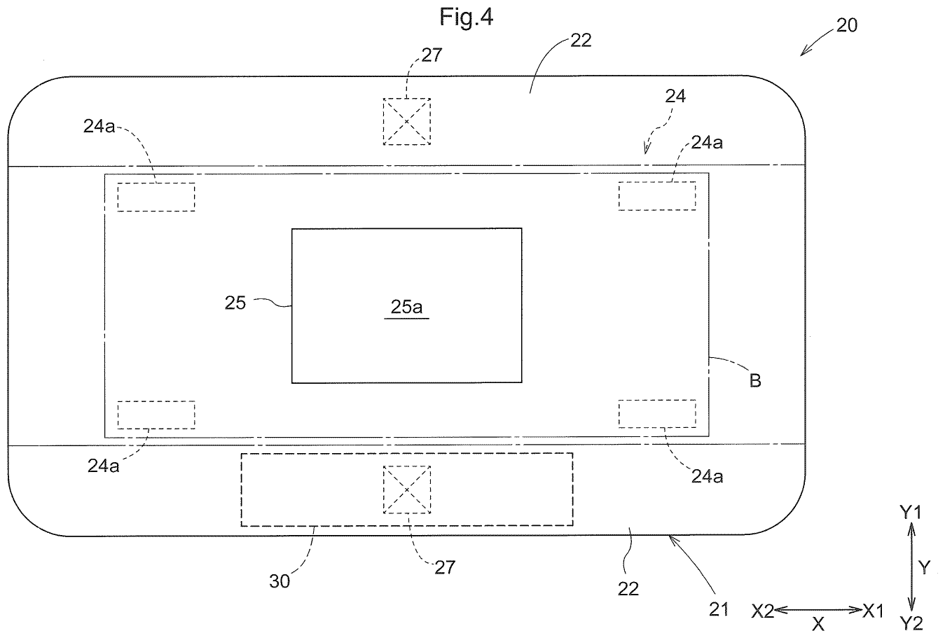

FIG. 4 is a plan view of the carriage 20 and the automated guided vehicle 30. The carriage 20 is provided with a supporter 25a that supports the object B to be transported, a plurality of wheels 24 that rotate on the floor surface F, and a body 21 to which the supporter 25a and the plurality of wheels 24 are attached. In the present embodiment, the wheels 24 are casters (wheels, each rotatable about a vertical axis extending in an up-down direction Z). As shown in FIGS. 2 and 3, in the present embodiment, the supporter 25a is a portion that comes into contact with the object B to be transported, of a lifting and lowering device 25, which will be described later. Here, the direction in which the carriage 20 travels is referred to as a travel direction X. The direction extending in the vertical direction is referred to as an up-down direction Z. The direction orthogonal to the travel direction X as viewed in the up-down direction is referred to as a width direction Y. One side in the width direction Y is referred to as a first side Y1 in the width direction, and the other side is referred to as a second side Y2 in the width direction. One side in the travel direction X is referred to as a first side X1 in the travel direction, and the other side is referred to as a second side X2 in the travel direction.

In the present embodiment, the body 21 is provided with work platforms 22 disposed outward, in the width direction Y, of the area overlapping the object B to be transported as viewed in the up-down direction, and configured to be ridden by an operator performing work on the object B to be transported. Here, “outward in the width direction Y” indicates a direction toward the outer edge of the body 21 in the width direction Y, i.e. the direction away from the center of the body 21 in the width direction Y. In the example shown in FIG. 4, the work platforms 22 are provided on two sides of the body 21 in the width direction Y.

In the present embodiment, the carriage 20 is provided with a plurality of support wheels 24a, which are wheels 24 arranged in areas overlapping the object B to be transported as viewed in the up-down direction. The wheels 24 are respectively fixed to the lower end portions of support columns 23 that extend downward from the body 21. In the example in the figure, four support columns 23 are provided. In the front and rear portions of the body 21, the support columns 23 are separately arranged on the left and right sides. In the example shown in FIG. 4, all of the wheels 24 are the support wheels 24a arranged in areas overlapping the object B to be transported as viewed in the up-down direction.

As shown in FIGS. 2 and 3, in the present embodiment, the carriage 20 is provided with the lifting and lowering device 25 that lifts and lowers the object B to be transported, above the body 21. The lifting and lowering device 25 is provided with a downward protrusion 25b that protrudes downward from the body 21. As shown in FIG. 4, the lifting and lowering device 25 is provided on a central portion of the body 21. The lifting and lowering device 25 is provided within the area surrounded by the four support wheels 24a (the four support columns 23) in a plan view. The lifting and lowering device 25 lifts and lowers the object B to be transported while supporting the object B to be transported from below. In this way, if the carriage 20 is provided with the lifting and lowering device 25, work such as assembly work can be performed with the height of the object B to be transported changed, which improves workability.

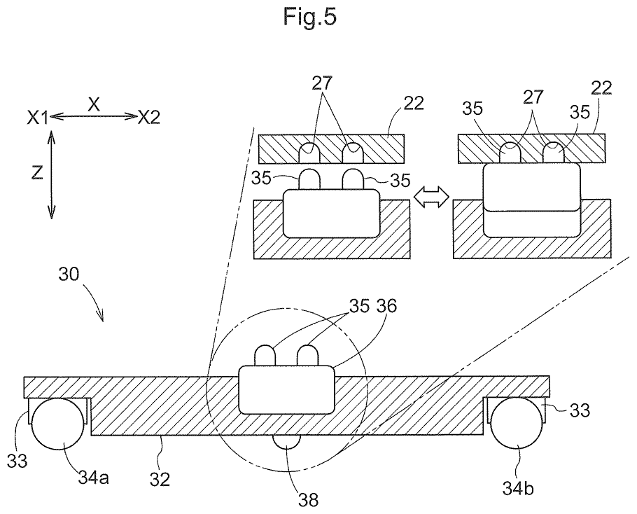

FIG. 5 is a side view of the automated guided vehicle 30. The automated guided vehicle 30 is provided with drive wheels (34a, 34b) that rotate on the floor surface F and drive sources 33 that drive the drive wheels (34a, 34b). In the present embodiment, the automated guided vehicle 30 is provided with first wheels 34a and second wheels 34b, each of which is a drive wheel driven by a drive source 33. The drive sources 33 are, for example, a rotating electric machine.

In the present embodiment, the drive source 33 and the drive wheels (34a, 34b) are supported by a main body 32. The main body 32 is a main portion that constitutes the body of the automated guided vehicle 30. In the example shown in the figure, the first wheels 34a and the second wheels 34b are respectively supported at two end portions of the main body 32 in the longitudinal direction thereof.

In the present embodiment, the automated guided vehicle 30 is provided with auxiliary wheels 38 supported on the main body 32. The auxiliary wheels 38 are casters. In the example in the figure, the auxiliary wheels 38 are provided between the first wheels 34a and the second wheels 34b. Note that, if the travel path P is formed with use of a guiding means such as magnetic markers, the automated guided vehicle 30 is provided with other components necessary for autonomous travel, such as a marker reader.

The automated guided vehicle 30 is provided with couplers 35 that are coupled to the carriage 20. The couplers 35 are each configured to be coupled to the body 21 in a state of being restricted from rotating about the up-down axis relative to the body 21. Examples of the couplers 35 include engagement protrusions that engage with engagement holes of the carriage 20, engagement holes that engage with engagement protrusions of the carriage 20, and arms that grip a portion of the carriage 20, and so on. In the present embodiment, the couplers 35 are a plurality of protrusions. In the example shown in FIG. 5, the couplers 35 are a pair of engagement pins aligned in the longitudinal direction of the body (main body 32) of the automated guided vehicle 30. In the state where the couplers 35 are coupled to the body 21 of the carriage 20, the pair of engagement pins are arranged in such a manner as to be aligned in the longitudinal direction of the body 21. With such an arrangement, the automated guided vehicle 30 can be coupled to the body 21 in the state of being restricted from rotating about the up-down axis relative to the body 21. Note that the couplers 35 may be engagement protrusions each having a polygonal cross-section. The couplers 35 may also be engagement holes each having a polygonal cross-section. The couplers 35 are each configured to be able to be coupled to and uncoupled from the carriage 20 by, for example, an operator or a control device 40, which will be described later.

In the present embodiment, the couplers 35 are coupled to the carriage 20 in such a manner that the automated guided vehicle 30 falls inside the body 21 in the width direction Y as viewed in the up-down direction. Note that the couplers 35 may be coupled to the carriage 20 in such a manner that 80% or more of the length of the automated guided vehicle 30 in the width direction Y falls inside the body 21 as viewed in the up-down direction. The couplers 35 may be coupled to the carriage 20 in such a manner that 90% or more of the length of the automated guided vehicle 30 in the width direction Y falls inside the body 21 as viewed in the up-down direction.

In the present embodiment, the couplers 35 are coupled to the carriage 20 in such a manner that the automated guided vehicle 30 falls inside the body 21 in the travel direction X as viewed in the up-down direction. Note that the couplers 35 may be coupled to the carriage 20 in such a manner that 80% or more of the length of the automated guided vehicle 30 in the travel direction X falls inside the body 21 as viewed in the up-down direction. The couplers 35 may be coupled to the carriage 20 in such a manner that 90% or more of the length of the automated guided vehicle 30 in the travel direction X falls inside the body 21 as viewed in the up-down direction.

As shown in FIG. 4, the automated guided vehicle 30 drives the drive wheels (34a, 34b) with the drive sources 33 to move the carriage 20, while the couplers 35 are coupled to the body 21 at positions that are outward of the supporter 25a of the body 21 in the width direction Y. Therefore, even if there is no space for the automated guided vehicle 30 to be placed directly below, or forward of, or rearward of the supporter 25a of the carriage 20, the automated guided vehicle 30 can be coupled to the carriage 20 and the carriage 20 can be moved by the drive force of the automated guided vehicle 30. At this time, the couplers 35 are coupled to the body 21 in the state of being restricted from rotating about the up-down axis relative to the body 21. Therefore, even if the automated guided vehicle 30 is coupled only to one side of the carriage 20 in the width direction Y, rather than to two sides in the width direction Y, it is easier to prevent the travel direction of the carriage 20 and the travel direction of the automated guided vehicle 30 from being displaced, and to keep them parallel to each other. Therefore, even if a structure or a mechanism necessary for the carriage 20 is present directly below, or forward of, or rearward of the supporter 25a of the carriage 20, the carriage 20 can be moved by the automated guided vehicle 30. Furthermore, if the distance between the carriage 20 and the automated guided vehicle 30 as viewed in the up-down direction is long, the couplers 35 need to be long as well. If the strength of the couplers 35 is insufficient, the carriage 20 may travel in an unstable manner. However, as described above, in the case where the couplers 35 are coupled to the body 21 at positions outward of the supporter 25a of the body 21 in the width direction Y, even if the automated guided vehicle 30 is also disposed outward of the supporter 25a of the body 21 in the width direction Y, there is no need to increase the length of the couplers 35, and the carriage 20 can be moved stably.

Furthermore, in the present embodiment, the automated guided vehicle 30 is disposed outward of the downward protrusion 25b of the lifting and lowering device 25 in the width direction Y while the couplers 35 are coupled to the body 21. With such a configuration, even if the carriage 20 is provided with the lifting and lowering device 25 that lifts and lowers the object B to be transported, the automated guided vehicle 30 can be appropriately disposed in such a manner that the automated guided vehicle 30 can move the carriage 20 without interfering with the lifting and lowering device 25.

Furthermore, in the present embodiment, the couplers 35 are coupled to the body 21 at positions outward of the support wheels 24a (specifically, the plurality of support wheels 24a) of the body 21 in the width direction Y. With such a configuration, the automated guided vehicle 30 is coupled to the body 21 of the carriage 20 at positions outward of the support wheels 24a of the carriage 20 in the width direction Y. Therefore, when the automated guided vehicle 30 moves relative to the carriage 20 before the automated guided vehicle 30 is coupled to the carriage 20 and after the automated guided vehicle 30 is separated from the carriage 20, the automated guided vehicle 30 and the support wheels 24a are less likely to interfere with each other. Therefore, it is easier to ensure a certain degree of freedom of the movement path of the automated guided vehicle 30 before and after the coupling with and separating from a carriage 20, and furthermore it is easier to improve the efficiency of the automated guided vehicle 30 in transporting the carriage 20.

The example shown in FIG. 4 shows a configuration in which the automated guided vehicle 30, which is coupled to only one side of the carriage 20 in the width direction Y, moves the carriage 20. However, as shown in FIG. 1, it is possible to employ a configuration in which automated guided vehicles 30 coupled to two sides of a carriage 20 in the width direction Y move the carriage 20.

In the present embodiment, each automated guided vehicle 30, whose couplers 35 are coupled to the body 21, is disposed outward of the support wheels 24a (specifically the plurality of support wheels 24a) in the width direction Y. With such a configuration, for example as shown in FIG. 1, it is possible to allow an automated guided vehicle 30, whose couplers 35 are separated from the body 21, to pass a position that is directly below a plurality of carriages 20 lined up on the first straight section P1 of the travel path P and is outward of the support wheels 24a. Therefore, it is easier to ensure a certain degree of freedom of the movement path of the automated guided vehicle 30 before and after the coupling with and separating from a carriage 20, and furthermore it is easier to improve the efficiency of the automated guided vehicle 30 in transporting the carriage 20.

Furthermore, in the present embodiment, the couplers 35 are coupled to the lower surface of a work platform 22. With such a configuration, it is possible to use the lower surface of the work platform 22 of the body 21 to provide coupling targets 27 to which the couplers 35 of an automated guided vehicle 30 are to be coupled, and it is also possible to use the space immediately below the work platform 22 of the body 21 to position the automated guided vehicle 30. Therefore, it is possible to suppress an increase in the size of the space in which the carriage 20 and the automated guided vehicle 30 are disposed, and it is easier to improve the space utilization efficiency in the transport facility 10. In the present embodiment, the couplers 35 are coupled to the lower surface of the work platform 22 in such a manner that the entirety of the automated guided vehicle 30 overlaps the work platform 22 as viewed in the up-down direction.

In the present embodiment, the coupling targets 27 to which the couplers 35 of the automated guided vehicle 30 are to be coupled are provided in the carriage 20. The coupling targets 27 are provided on the lower surfaces of the work platforms 22. In the example shown in FIG. 4, a plurality of coupling targets 27 are provided in the carriage 20. The coupling targets 27 are provided in each of the work platforms 22 provided on two sides of the body 21 in the width direction Y.

In the present embodiment, the coupling targets 27 are provided in the body 21 in such a manner as to face downward. In the example shown in FIG. 5, the coupling targets 27 are constituted by a pair of pin engagement holes formed in the lower surface of the work platforms 22 in such a manner as to open downward. In the example shown in the figures, the coupling targets 27, which are pin engagement holes, are each a hole with a bottom, but may be through holes that extend through the work platform 22 in an up-down direction.

In the present embodiment, the couplers 35 are formed in such a manner that the entirety thereof when coupled overlap the main body 32 as viewed in the up-down direction. Furthermore, the couplers 35 are configured to be movable in the up-down direction relative to the main body 32. Furthermore, the couplers 35 are formed on an upper portion of a lifting and lowering section 36 that is movable in the up-down direction relative to the main body 32. When the lifting and lowering section 36 is lowered with respect to the main body 32 and the lifting and lowering section 36 is in the lowered position, the couplers 35 are not engaged with the coupling targets 27 and are in a disengaged state. Thus, the automated guided vehicle 30 and the carriage 20 are in an uncoupled state. On the other hand, when the lifting and lowering section 36 is lifted relative to the main body 32 and the lifting and lowering section 36 is in a lifted position, the couplers 35 are engaged with the coupling targets 27. Thus, the automated guided vehicle 30 and the carriage 20 are in a coupled state.

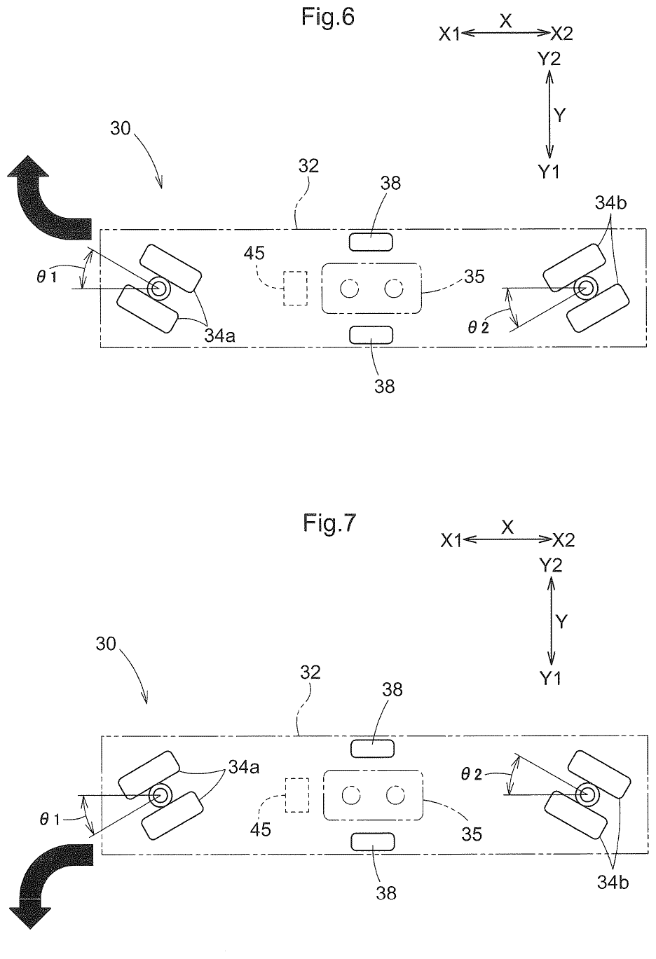

FIG. 6 is a diagram showing a state in which an automated guided vehicle 30, whose couplers 35 are not coupled to the body 21, is turning to the right. FIG. 7 is a diagram showing a state in which an automated guided vehicle 30, whose couplers 35 are not coupled to the body 21, is turning to the left. In the present embodiment, the automated guided vehicle 30 includes a steering controller 45 that controls steered wheels. In the present embodiment, the steering controller 45 is provided in the automated guided vehicle 30 as a portion of a control device 40, which will be described later.

In the present embodiment, the first wheels 34a and the second wheels 34b are each supported in such a manner as to be rotatable relative to the main body 32. That is to say, the first wheels 34a and the second wheels 34b are steered wheels controlled by the steering controller 45. In the example shown in the figure, the first wheels 34a are constituted by a pair of left and right wheels. The second wheels 34b are constituted by a pair of left and right wheels. As described above, the first wheels 34a and the second wheels 34b are drive wheels. Therefore, the automated guided vehicle 30 is configured to be capable of four-wheel driving.

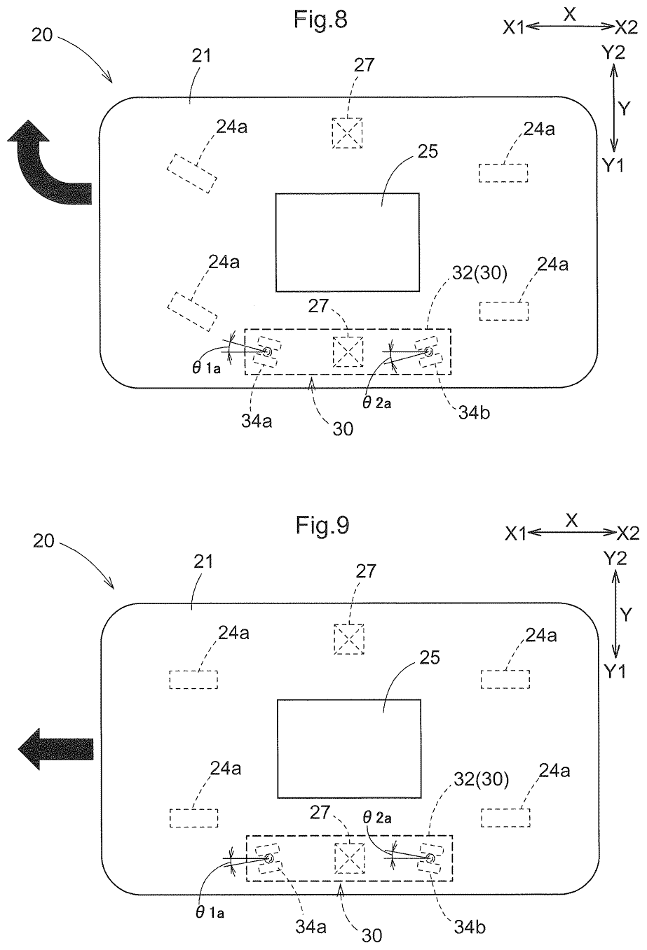

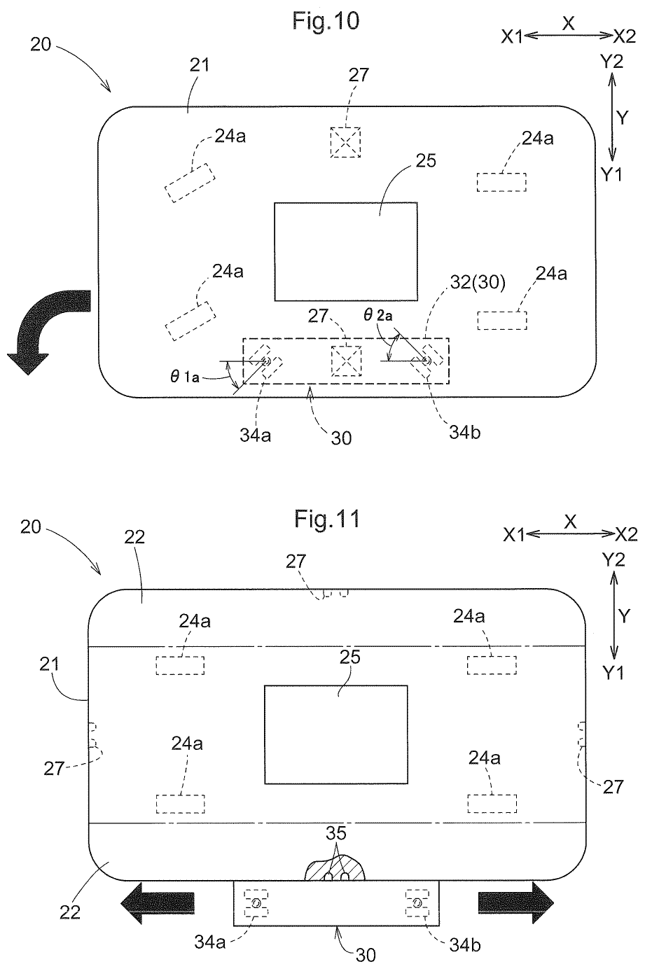

Hereinafter, an example of control of the steered wheels performed by the steering controller 45 will be described with reference to FIGS. 6 to 10. Note that FIGS. 8 to 10 each show a state in which the automated guided vehicle 30 is coupled to only one side of the carriage 20 in the width direction Y. In the following descriptions of FIGS. 8 to 10, the side to which the automated guided vehicle 30 is coupled (specifically, the side on which the couplers 35 are positioned with respect to the supporter 25a, i.e. the first side Y1 in the width direction in the examples shown in FIGS. 8 to 10) of the two sides in the width direction Y is referred to as the side that is “outward in the width direction Y”, and the opposite side (the second side Y2 in the width direction in the examples shown in FIGS. 8 to 10) is referred to as the side that is “inward in the width direction Y”. That is to say, for convenience, the side to which the automated guided vehicle 30 is not coupled, of the two outer sides in the width direction Y, is referred to as the side that is “inward in the width direction Y”. FIG. 8 is a diagram showing a state in which an automated guided vehicle 30 and a carriage 20, while the couplers 35 are coupled to the left side of the body 21, are turning to the right, i.e. a state in which the automated guided vehicle 30 coupled to the body 21 of the carriage 20 is turning inward in the width direction Y of the body 21. FIG. 9 is a diagram showing a state in which an automated guided vehicle 30 and a carriage 20, with the couplers 35 coupled to the left side of the body 21, are travelling straight. FIG. 10 is a diagram showing a state in which an automated guided vehicle 30 and a carriage 20, with the couplers 35 coupled to the left side of the body 21, are turning to the left, i.e. a state in which the automated guided vehicle 30 coupled to the body 21 of the carriage 20 is turning outward in the width direction Y of the body 21.

FIGS. 6 and 8 show a state in which an automated guided vehicle 30 turns to the right along the same curved section of the travel path P. In addition, in the following description of control, it is assumed that the trajectories of the first wheels 34a and the second wheels 34b of the automated guided vehicle 30 shown in FIG. 6 are the same as those of the automated guided vehicle 30 coupled to the first side Y1 in the width direction of the carriage 20 shown in FIG. 8. FIGS. 7 and 10 show a state in which an automated guided vehicle 30 turns to the left along the same curved section of the travel path P. In the following description of control, it is assumed that the trajectories of the first wheels 34a and the second wheels 34b of the automated guided vehicle 30 shown in FIG. 7 are the same as those of the automated guided vehicle 30 coupled to the first side Y1 in the width direction of the carriage 20 shown in FIG. 10.

Here, the inclination angle of the orientation of the steered wheels with respect to the travel direction X is referred to as the steering angle. In the following description of control, the steering angle of the first wheels 34a in the state where the couplers 35 are not coupled to the body 21 shown in FIG. 6 is referred to as a reference steering angle θ1 of the first wheels 34a at the time of a right turn, and the steering angle of the first wheels 34a in the state where the couplers 35 are not coupled to the body 21 shown in FIG. 7 is referred to as a reference steering angle θ1 of the first wheels 34a at the time of a left turn. In addition, in the following description of control, the steering angle of the second wheels 34b in the state where the couplers 35 are not coupled to the body 21 shown in FIG. 6 is referred to as a reference steering angle θ2 of the second wheels 34b at the time of a right turn, and the steering angle of the second wheels 34b in the state where the couplers 35 are not coupled to the body 21 shown in FIG. 7 is referred to as a reference steering angle θ2 of the second wheels 34b at the time of a left turn. Although not shown, the reference steering angle θ1 of the first wheels 34a and the reference steering angle θ2 of the second wheels 34b during straight travel in a state where the couplers 35 are not coupled to the body 21 are 0 degrees.

As shown in FIG. 9, a steering angle θ1a of the first wheels 34a and a steering angle θ2a of the second wheels 34b during straight travel in a state where the couplers 35 are coupled to the body 21 are adjusted by the steering controller 45 to be a steering angle for directing the automated guided vehicle 30 outward in the width direction Y compared to the reference steering angle θ1 and the reference steering angle θ2 during straight travel, which are 0 degrees.

The steering angle θ1a of the first wheels 34a and the steering angle θ2a of the second wheels 34b shown in FIG. 8 are steering angles in the case where the automated guided vehicle 30 coupled to the body 21 of the carriage 20 turns inward in the width direction Y of the body 21. The absolute value of the steering angle θ1a of the first wheels 34a shown in FIG. 8 is set to be smaller than that of the reference steering angle θ1 shown in FIG. 6. The absolute value of the steering angle θ2a of the second wheels 34b shown in FIG. 8 is set to be smaller than that of the reference steering angle θ2 shown in FIG. 6. That is to say, the steering angle θ1a and the steering angle θ2a shown in FIG. 8 are adjusted by the steering controller 45 to be steering angles for directing the automated guided vehicle 30 outward in the width direction Y compared to the reference steering angle θ1 and the reference steering angle θ2 shown in FIG. 6, respectively.

The steering angle θ1a of the first wheels 34a and the steering angle θ2a of the second wheels 34b shown in FIG. 10 are steering angles in the case where the automated guided vehicle 30 coupled to the body 21 of the carriage 20 turns outward in the width direction Y of the body 21. The absolute value of the steering angle θ1a of the first wheels 34a shown in FIG. 10 is set to be larger than that of the reference steering angle θ1 shown in FIG. 7. The absolute value of the steering angle θ2a of the second wheels 34b shown in FIG. 10 is set to be larger than that of the reference steering angle θ2 shown in FIG. 7. That is to say, the steering angle θ1a and the steering angle θ2a shown in FIG. 10 are adjusted by the steering controller 45 to be steering angles for directing the automated guided vehicle 30 outward in the width direction Y compared to the reference steering angle θ1 and the reference steering angle θ2 shown in FIG. 7, respectively.

The examples of control shown in FIGS. 6 to 10 are examples in which the steering angle is adjusted by the steering controller 45 in the case where the couplers 35 of the automated guided vehicle 30 are coupled to the left side of the body 21. In this case, the side that is outward in the width direction Y is the left side, and the side that is inward in the width direction Y is the right side. However, although not shown, even when the couplers 35 are coupled to the right side of the body 21, the steering controller 45 adjusts the steering angle θ1a and the steering angle θ2a in the state where the couplers 35 are coupled to the body 21 to be steering angles for directing the automated guided vehicle 30 outward in the width direction Y compared to the reference steering angle θ1 and the reference steering angle θ2. In such a case, the side that is outward in the width direction Y is the right side, and the side that is inward in the width direction Y is the left side.

In the examples shown in FIGS. 6 to 10, all of the front and rear drive wheels (the first wheels 34a and the second wheels 34b) also serve as steered wheels. In addition, in the examples shown in FIGS. 6 to 10, the steering angles of the first wheels 34a and the steering angles of the second wheels 34b are both controlled by the steering controller 45. However, in the present embodiment, only the steering angle of the first wheels 34a or only the steering angle of the second wheels 34b may be adjusted by the steering controller 45. Alternatively, for example, either the first wheels 34a or the second wheels 34b may be configured to function as steered wheels that also serve as drive wheels, and the other wheels may be configured to function as driven wheels that are neither drive wheels nor steered wheels. Alternatively, either the first wheels 34a or the second wheels 34b may be configured to function as drive wheels, and the other may be configured to function as steered wheels.

In the present embodiment, the automated guided vehicle 30 includes steered wheels that also serve as drive wheels or that are provided separately from the drive wheels, and a steering controller 45 that controls the steered wheels. As described above, when the couplers 35 are coupled to the body 21, the steering controller 45 adjusts the steering angles to direct the automated guided vehicle 30 outward in the width direction Y compared to when the couplers 35 are not coupled to the body 21. When the automated guided vehicle 30 is coupled to only one side of the carriage 20 in the width direction Y instead of two sides in the width direction Y, the travel direction of the automated guided vehicle 30 is likely to gradually incline inward in the width direction Y (i.e. toward the supporter 25a) due to the running resistance of the carriage 20. In the present embodiment, the steering angle is adjusted as described above, and therefore, even in such a case, it is easy to adjust the travel direction X of the carriage 20 to the desired direction. Moreover, the above-described control for adjusting the steering angle to direct the automated guided vehicle 30 outward in the width direction Y can be, for example, feedforward control. With such a configuration, it is easier to adjust the travel direction X of the carriage 20 to the desired direction, and the number of times the steered wheels are adjusted can be reduced, compared to the case where the steered wheels are controlled only through feedback control performed to make the travel direction X of the carriage 20 coincide with the target, and it is possible to reduce wear on the steered wheels and the drive wheels.

In addition, in the present embodiment, the steering controller 45 performs adjustment to increase the steering angle of the automated guided vehicle 30 outward in the width direction Y as the weight of the carriage 20 including the object B to be transported increases. With such a configuration, even if the weight of the carriage 20 including the object B to be transported changes each time, the travel direction of the carriage 20 and the travel direction of the automated guided vehicle 30 can be easily prevented from being misaligned with each other.

In the present embodiment, when the carriage 20 travels along a travel path P with many right turns, the couplers 35 of the automated guided vehicle 30 may be coupled to the left side of the body 21, and when the carriage 20 travels along a travel path P with many left turns, the couplers 35 of the automated guided vehicle 30 may be coupled to the right side of the body 21. As shown in FIG. 8, when the couplers 35 of the automated guided vehicle 30 are coupled to the left side of the body 21, the absolute value of the steering angle θ1a at the time of a right turn is adjusted by the steering controller 45 to be smaller than that of the reference steering angle θ1. In this way, with the configuration in which the couplers 35 of the automated guided vehicle 30 are coupled to the side opposite to the direction in which the body 21 is curving, it is possible to reduce the adjustment amount of the steering angle and to utilize the force in the left-right direction acting on the automated guided vehicle 30 from the carriage 20 to efficiently move the carriage 20. The change in the position where the above-described couplers 35 are coupled in accordance with the travel path P may be controlled by a control device 40, which will be described later.

FIG. 1 is referenced again. In the present embodiment, the transport facility 10 further includes a control device 40 that controls automated guided vehicles 30. In the example shown in FIG. 1, the transport facility 10 includes a plurality of carriages 20 and a plurality of automated guided vehicles 30. The automated guided vehicles 30 are controlled by the control device 40, and are configured to self-propel along the travel path P.

In the present embodiment, the control device 40 includes a computation processing unit such as a CPU (Central Processing Unit), and a main storage device that can be referenced by the computation processing unit such as a RAM (Random Access Memory) or a ROM (Read Only Memory). The functions of the control device 40 are realized through cooperation between hardware included in the control device 40 and a program executed on hardware such as the computation processing unit. Specifically, the functions of the control device 40 are realized by the control device 40 executing a program stored in a storage device (the main storage device, a separately provided storage unit, or the like). In other words, a program (for example, a transport control program) for enabling a computer to realize the functions of the control device 40 is stored in a storage device that can be referenced by the computer. For example, this program is provided from a storage medium or via a communication network. The program thus provided is stored in a storage device that can be referenced by a computer. In the present embodiment, the control device 40 (specifically, the arithmetic processing device included in the control device 40) functions as a “computer”. The control device 40 may be mounted on each automated guided vehicle 30, or may be a higher-level control device installed in a control facility (not shown). In addition, when the control device 40 includes a plurality of pieces of hardware that are separated in such a manner as to be able to communicate with each other, some of the pieces of hardware may be provided in the automated guided vehicle 30 and the remaining pieces of hardware may be installed in a control facility (not shown). In the present embodiment, the steering controller 45 of the control device 40 is provided in each automated guided vehicle 30.

In the present embodiment, the control device 40 performs a reversing operation to reverse the orientation of the automated guided vehicle 30 in the front-rear direction each time a predetermined reversing condition is satisfied. When the drive wheels of the automated guided vehicle 30 are driven to move the carriage 20 while the couplers 35 of the automated guided vehicle 30 are coupled at positions that are outward, in the width direction Y, of the supporter 25a of the body 21, an uneven load acts on the drive wheels, and therefore wear on the drive wheels is likely to progress unevenly in the width direction Y. In the present embodiment, the control device 40 performs the reversing operation of the automated guided vehicle 30 each time a predetermined reversing condition is satisfied, and therefore it is easier to avoid uneven wear on the drive wheels.

In the present embodiment, the orientation of the automated guided vehicle 30 in the front-rear direction is reversed by changing the travel direction X of the automated guided vehicle 30 in such a manner as to swap the positions of the first wheels 34a and the second wheels 34b. The predetermined reversing condition is, for example, that the travel distance of the automated guided vehicle 30 exceeds a predetermined distance. Alternatively, the reversing condition may be that a predetermined time has elapsed. Alternatively, the load on the drive wheels is predicted and calculated based on various kinds of information such as the weight of the carriage 20, the travel distance, and the travel direction of the carriage 20 when the automated guided vehicle 30 is coupled to the carriage 20, and the reversing condition may be that the cumulative load, which is the result of the calculation, has reached a predetermined value.

### Other Embodiments

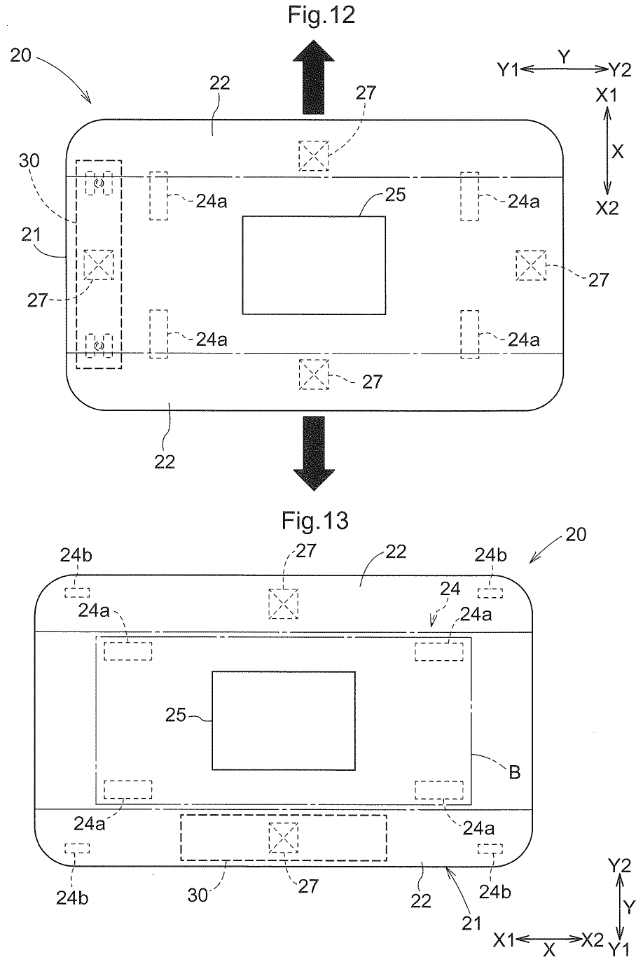

Next, other embodiments of the transport facility will be described.
(1) The above embodiment describes, as an example, a configuration in which each carriage 20 is provided with the lifting and lowering device 25 and the supporter 25a thereof is a part that comes into contact with the object B to be transported, of the lifting and lowering device 25. However, the present disclosure is not limited to such an example. For example, the carriage 20 may not be provided with the lifting and lowering device 25, and the supporter 25a may serve as a platform of the carriage 20.
(2) The above embodiment describes, as an example, a configuration in which the couplers 35 are coupled to the lower surface of the work platform 22. However, the present disclosure is not limited to such an example. For example, as shown in FIG. 11, a configuration in which the couplers 35 are coupled to a side surface of the work platform 22 may be employed. Also, a configuration in which the carriage 20 is not provided with the work platform 22 may be employed. Alternatively, for example, a configuration in which the couplers 35 are coupled to the lower surface or a side surface of the body 21 may be employed. Alternatively, the work platform 22 may be provided only on one side in the width direction Y.
(3) The above embodiment describes, as an example, a configuration in which the couplers 35 are coupled to the coupling targets 27 provided on one side or two sides of the body 21 in the widthwise direction, and the automated guided vehicle 30 moves the carriages 20 in the lengthwise direction of the body 21. However, the present disclosure is not limited to such an example. For example, as shown in FIG. 12, it is possible to employ a configuration in which the coupling targets 27 are provided on the front, rear, left, and right sides of the body 21, the couplers 35 are coupled to the coupling targets 27 provided on one side in the lengthwise direction of the body 21, and the automated guided vehicle 30 moves the carriage 20 in the widthwise direction of the body 21.
(4) The above embodiment describes, as an example, a configuration in which all of the wheels 24 are support wheels 24a disposed in the area overlapping the object B to be transported as viewed in the up-down direction. However, the present disclosure is not limited to such an example, and it is possible to employ a configuration in which some or all of the wheels 24 are not support wheels 24a. For example, as shown in FIG. 13, the plurality of wheels 24 include support wheels 24a and non-support wheels 24b that are disposed in an area not overlapping the object B to be transported as viewed in the up-down direction. In the example shown in FIG. 13, the non-support wheels 24b are auxiliary wheels provided in outer edge areas of the carriage 20.
(5) The above embodiment describes, as an example, a configuration in which the couplers 35 can be coupled to the body 21 at positions outward of the support wheels 24a in the width direction Y. However, the present disclosure is not limited to such an example. For example, it is possible to employ a configuration in which the couplers 35 are coupled to the body 21 at positions that are outward of the supporter 25a in the width direction Y and inward of the support wheels 24a in the width direction Y.
(6) The above embodiment describes, as an example, a configuration in which all of the drive wheels also serve as steered wheels. However, the present disclosure is not limited to such an example. For example, a configuration is possible where some wheels of the automated guided vehicle 30 are drive wheels that are coupled to the drive source 33 and do not serve as steered wheels, and some other wheels are steered wheels that are controlled by the steering controller 45 and do not serve as drive wheels.
(7) The above embodiment describes, as an example, a configuration in which reversing control is performed by the control device 40 whose hardware is partially provided in each automated guided vehicle 30. However, the present disclosure is not limited to such an example. For example, a control device 40 provided outside a plurality of automated guided vehicles 30 may manage the automated guided vehicles 30 to perform reversing control, or only a control device 40 provided in each automated guided vehicle 30 may perform reversing control.
(8) Note that the configuration disclosed in the above embodiment may also be applied in combination with the configurations disclosed in the other embodiments as long as no contradiction arises. Regarding other configurations, the embodiments disclosed herein are merely illustrative in all respects. Therefore, various modifications can be made as appropriate without departing from the spirit of the present disclosure.

### Summary of the Above Embodiments

Hereinafter, the transport facility described above will be described.

A transport facility according to the present disclosure is a transport facility including: a carriage configured to support an object to be transported; and an automated guided vehicle configured to be coupled to the carriage and self-propelled to move the carriage on a floor surface. The automated guided vehicle includes: a coupler configured to be coupled to the carriage; a drive wheel configured to roll on the floor surface; and a drive source configured to drive the drive wheel, the carriage includes: a supporter configured to support the object to be transported; a plurality of wheels configured to roll on the floor surface; and a body to which the supporter and the plurality of wheels are attached, with a travel direction being a direction in which the carriage travels, and a width direction being a direction orthogonal to the travel direction as viewed in an up-down direction, the coupler is configured to be coupled to the body in such a manner that the coupler is restricted from rotating about an up-down axis relative to the body, and the automated guided vehicle drives the drive wheel with the drive source to move the carriage, while the coupler is coupled to the body at a position outward of the supporter in the width direction.

With this configuration, even if there is no space for the automated guided vehicle to be placed directly below, or forward of, or rearward of the supporter of the carriage, the automated guided vehicle can be coupled to the carriage and the carriage can be moved by the drive force of the automated guided vehicle. At this time, the coupler is coupled to the body in the state where relative rotation of the coupler about the up-down axis is restricted. Therefore, even if the automated guided vehicle is coupled only to one side of the carriage in the width direction, rather than to two sides in the width direction, it is easier to prevent the travel direction of the carriage and the travel direction of the automated guided vehicle from being misaligned with each other. Therefore, even if a structure or a mechanism necessary for the carriage is present directly below, or forward of, or rearward of the supporter of the carriage, the carriage can be moved by the automated guided vehicle.

In one aspect, it is preferable that the plurality of wheels of the carriage include a plurality of support wheels disposed in an area overlapping the object to be transported as viewed in the up-down direction, and the coupler is coupled to the body at a position outward of the plurality of support wheels in the width direction.

With this configuration, the automated guided vehicle is coupled to the body of the carriage at a position that is outward of the support wheels of the carriage in the width direction. Therefore, it is possible to prevent the automated guided vehicle and the support wheels from interfering with each other when the automated guided vehicle moves relative to the carriage before the automated guided vehicle is coupled to the carriage or after the automated guided vehicle is separated from the carriage. Therefore, it is easier to ensure a certain degree of freedom of the movement path of the automated guided vehicle before and after the coupling with and separating from the carriage, and furthermore it is easier to improve the efficiency of the automated guided vehicle in transporting the carriage.

In one aspect, it is preferable that the body includes a work platform disposed outward, in the width direction, of an area overlapping the object to be transported as viewed in the up-down direction, and configured to be ridden by an operator performing work on the object to be transported, and the coupler is coupled to a lower surface of the work platform.

With this configuration, a coupling target to which the coupler of the automated guided vehicle is to be coupled can be provided with use of the lower surface of the work platform of the body, and the space immediately below the work platform of the body can be used to dispose the automated guided vehicle. Therefore, it is possible to suppress an increase in the size of the space in which the carriage and the automated guided vehicle are disposed, and it is easier to improve the space utilization efficiency in the transport facility.

In one aspect, it is preferable that the carriage further includes a lifting and lowering device configured to lift and lower the object to be transported above the body, the supporter is a portion of the lifting and lowering device and comes into contact with the object to be transported, the lifting and lowering device includes a downward protrusion protruding downward from the body, and the automated guided vehicle is disposed outward of the downward protrusion in the width direction while the coupler is coupled to the body.

With this configuration, even if the carriage is provided with a lifting and lowering device that lifts and lowers an object to be transported, it is possible to place the automated guided vehicle appropriately without interfering with the lifting and lowering device, and move the carriage.

In one aspect, it is preferable that the transport facility further includes a control device configured to control the automated guided vehicle, wherein the control device executes a reversing operation to reverse an orientation of the automated guided vehicle in a front-rear direction, each time a predetermined reversal condition is satisfied.

When the drive wheel is driven to move the carriage while the coupler of the automated guided vehicle are coupled to the body at a position that is outward in the width direction of the supporter, an uneven load acts on the drive wheel, and therefore wear on the drive wheel is likely to progress unevenly in the width direction. With the above configuration, the reversing operation of the automated guided vehicle is performed each time a predetermined reversing condition is satisfied. Therefore, it is easier to avoid uneven wear on the drive wheel.

In one aspect, it is preferable that the automated guided vehicle further includes: a steered wheel configured to serve as the drive wheel or provided separately from the drive wheel; and a steering controller configured to control the steered wheel, and the steering controller adjusts a steering angle to direct the automated guided vehicle more outward in the width direction while the coupler is coupled to the body than while the coupler is not coupled to the body, where the steering angle is an inclination angle of an orientation of the steering wheel with respect to the travel direction.

When the automated guided vehicle is coupled to only one side of the carriage in the width direction instead of two sides in the width direction, the travel direction of the automated guided vehicle is likely to gradually incline inward in the width direction due to the running resistance of the carriage. However, with the above configuration, even in such a case, it is easier to adjust the travel direction of the carriage to the desired direction.

In one aspect, it is preferable that the steering controller makes an adjustment to increase the steering angle to direct the automated guided vehicle more outward in the width direction as the carriage including the object to be transported increases in weight.

With such a configuration, even if the weight of the carriage including the object to be transported changes each time, the travel direction of the carriage and the travel direction of the automated guided vehicle can be easily prevented from being misaligned with each other.

What is claimed is:

1. A transport facility comprising:
a carriage configured to support an object to be transported; and
an automated guided vehicle configured to be coupled to the carriage and self-propelled to move the carriage on a floor surface, and
wherein:
the automated guided vehicle comprises:
a coupler configured to be coupled to the carriage;
a drive wheel configured to roll on the floor surface; and
a drive source configured to drive the drive wheel,
the carriage comprises:
a supporter configured to support the object to be transported;
a plurality of wheels configured to roll on the floor surface; and
a body to which the supporter and the plurality of wheels are attached,
a travel direction is a direction in which the carriage travels, and a width direction is a direction orthogonal to the travel direction as viewed in an up-down direction,
the coupler is configured to be coupled to the body in such a manner that the coupler is restricted from rotating about an up-down axis relative to the body, and
the automated guided vehicle drives the drive wheel with the drive source to move the carriage, while the coupler is coupled to the body at a position outward of the supporter in the width direction.

2. The transport facility according to claim 1,
wherein the plurality of wheels of the carriage comprise a plurality of support wheels disposed in an area overlapping the object to be transported as viewed in the up-down direction, and
wherein the coupler is coupled to the body at a position outward of the plurality of support wheels in the width direction.

3. The transport facility according to claim 1,
wherein the body comprises a work platform disposed outward, in the width direction, of an area overlapping the object to be transported as viewed in the up-down direction, and configured to be ridden by an operator performing work on the object to be transported, and
wherein the coupler is coupled to a lower surface of the work platform.

4. The transport facility according to claim 1, wherein:
the carriage further comprises a lifting and lowering device configured to lift and lower the object to be transported above the body,
the supporter is a portion of the lifting and lowering device and comes into contact with the object to be transported,
the lifting and lowering device comprises a downward protrusion protruding downward from the body, and
the automated guided vehicle is disposed outward of the downward protrusion in the width direction while the coupler is coupled to the body.

5. The transport facility according to claim 1, further comprising:
a control device configured to control the automated guided vehicle, and
wherein the control device executes a reversing operation to reverse an orientation of the automated guided vehicle in a front-rear direction, each time a predetermined reversal condition is satisfied.

6. The transport facility according to claim 1,
wherein the automated guided vehicle further comprises:
a steered wheel configured to serve as the drive wheel or provided separately from the drive wheel; and
a steering controller configured to control the steered wheel, and
wherein the steering controller adjusts a steering angle to direct the automated guided vehicle more outward in the width direction while the coupler is coupled to the body than while the coupler is not coupled to the body, where the steering angle is an inclination angle of an orientation of the steering wheel with respect to the travel direction.

7. The transport facility according to claim 6,
wherein the steering controller makes an adjustment to increase the steering angle to direct the automated guided vehicle more outward in the width direction as the carriage including the object to be transported increases in weight.
